(19) United States
(12) Patent Application Publication
(10) Pub. No.: US 2007/0178207 A1
(43) Pub. Date: Aug. 2, 2007

(54) Process for the preparation of colored icing sweetners, products obtainable by said processs and use thereof in the alimentary field

(76) Inventor: Mario Angelini, Folignano (IT)

Correspondence Address: PEARNE & GORDON LLP, 1801 EAST 9TH STREET, SUITE 1200, CLEVELAND, OH, 44114-3108, US

(21) Appl. No.: 10/589,300

(22) PCT Filed: Nov. 29, 2004
(86) PCT No.: PCT/IB04/03900

§ 371 Date: Aug. 14, 2006

(30) Foreign Application Priority Data
Feb. 16, 2004 (IT) MI2004A000250

(51) Int. Cl. A23L 1/236

(52) U.S. Cl. 426/548; 426/540

(57) ABSTRACT

The invention relates to a process for industrial application for preparing icing sweeteners colored with any coloring agent for food use. The process basically consists in subjecting to a simultaneous mixing-refining step a mixture comprising sugar or a surrogate thereof, and one or more coloring agents for food use, by means of a high speed mill. The mill also relates to colored sweetening products that can be obtained with said process and to their use in the alimentary field.

The present invention relates to a process for industrial application for preparing icing sweeteners colored with any coloring agent for use in food. Said process is carried out in one step (single-step or one-pot process) and basically consists in subjecting to simultaneous mixing-refining a mixture comprising a sugar or a surrogate thereof and one or more coloring agents for use in food, by using a high speed mill.

The present invention also relates to products that can be obtained with said process and to their use in the alimentary field.

In the alimentary field it is widely known about the use of various ingredients, such as for instance coloring agents, sweeteners, gelatins and others, for treating food products, for improving their appearance, their attractiveness and also their organoleptic properties.

Said ingredients preferably apply in particular to the confectionery field, where color for instance has a main role.

It is therefore important also for an individual consumer to have ready-for-use products, which can be easily applied (in particular onto the finished product) and which are cheap, stable and not toxic.

By mere way of example, an excellent and versatile option would be to have a wide range of powdered products, with different colors, to be added at will for instance with a metering can or by means of a sprinkling sieve, to the finished product.

Unfortunately, to the purpose referred to above only icing sugar, white-colored as is known, and powdered cocoa are available at present.

Coloring agents for use in food are marketed in liquid form (solubilized in water-based solvents) or as paste or gel, or as concentrated pure powder. The application of the first two formulations, i.e. in liquid and gel form (for instance by means of brushes, sprays, spatulas and so on), is anyhow difficult and inaccurate and cannot be carried out successfully by every user.

Moreover, coloring agents have some drawbacks even if they are provided for as concentrated pure powder. As a matter of fact, they cannot be used as such because of their toxicity (indeed, their maximum concentration as allowed by law is of 4% on 100 g of food product). Their dilution by mixing with neutral excipients is not simple and is generally unsatisfying as far as the final result is concerned (often the result is a non-homogenously colored product).

Among the three possible forms of food coloring agents as referred to above, the market consumes about 50-60% in solid concentrated form (it is also the cheapest and most stable form), 30-40% in liquid form (it can however be preserved for a limited lapse of time), only 1-4% as paste or gel (by the way, it is the most expensive formulation).

In the confectionery field 30-40% of pastries are reported to be sprinkled with white icing sugar. Today no colored icing sugar exists on the market.

Still referring to cakes, many people working in this field would positively consider the possibility of replacing sugar icing, widely used as covering agent, even as colored covering agent (icing is sometimes pleasant to be seen, but its taste is nauseating), with other more pleasant and delicate ingredients, such as for instance icing sugars of various colors. Therefore, there is the need for effectively and stably colored powdered sweeteners, which are ready and simple to use, as traditional white icing sugar and powdered cocoa.

Now, the present invention has solved the technical problem described above in an efficient and cheap manner by finding and improving an innovative process for industrial application for preparing icing sugar or surrogates thereof, colored with any coloring agent for use in food. Said process can apply to any sweetening agent (thus taking into account also consumers' diet requirements, which may be related for instance to health problems such as diabetes, overweight, obesity), as well as to any type of coloring agent for use in food or a mixture thereof.

According to one of the particularly preferred features of the invention, sucrose and at least a coloring agent (the adding sequence is not binding), suitably metered, are introduced into a high speed mill (working at 4000-5000 rpm). Then, in one step, the mixture of the two components undergoes simultaneous mixing-refining until the desired icing sugar with the desired granulometry (basically a very fine powder) and with a perfectly homogenous color is obtained.

The granulometry of colored icing sweeteners obtained with the single-step or one-pot process according to the invention is on average below 200 μ of diameter, preferably below 150 μ of diameter, more preferably below 100 μ.

In a particularly preferred embodiment of the invention, the granulometry of said colored icing sweeteners is on average of a diameter of 5-50 μ, still more preferably of 10-30 μ.

The products thus obtained are ready for use and have proved homogeneous, stable and easy to use and add. The coloring agent/agents used is/are added up to a maximum percentage of 4% by weight of coloring agent with respect to the sweetener or to the sweetening mixture.

According to another preferred feature of the invention, the sweetener is sucrose, used either in granulated/refined form or already in icing form. Since the average granulometry of commercial refined sugar is of 300 to 600 μ of diameter, whereas the granulometry of icing sugar is on average of 10 to 40 μ of diameter, the time of the mixing-refining process required for obtaining the desired final products will be extremely shorter if icing sugar is used.

Still preferably, instead of sucrose or mixed with the latter, any other type of sweetener for use in food can be used, such as for instance fructose, glucose, lactose, levulose, sorbitol, saccharine, aspartame, acesulfame, cyclamate and all others that are well known to people skilled in the art. In this case, in order to take into account the different sweetening power of the various sweeteners, it is possible/necessary to add a suitable amount of at least a neutral excipient, i.e. with non-sweetening effect, such as for instance starch, potato starch, flour, talcum and other known excipients to this purpose.

Also the mixture sucrose/coloring agent/s can be in its turn added with a suitable percentage of at least a neutral excipient, for instance starch, potato starch, flour, talcum, acting as lubricating agent preventing lump formation, but also simply as diluting agent, thus obtaining a less sweet, more delicate-tasted product.

Other ingredients that are used as known in the alimentary field as additives, flavoring agents, preservatives, stabilizers, can be added as well to the products referred to above.

The excipient and/or excipient mixture is added in a freely variable amount depending on requirements. As far as sucrose is concerned, for instance, starch addition up to 5-10% by weight with respect to sucrose is regarded as preferred.

The icing sweeteners obtained with the process according to the present invention can then be made waterproof for instance by microencapsulation with suitable covering agents, using appropriate vaporizers. This waterproof treatment improves the preservation of flowing properties of colored powder, preventing both lump formation and product packing during storage.

The mixing-refining process is carried out as a rule at room temperature, at 4000-5000 rpm for the time required for obtaining a final product having an impalpable consistency, just like white icing sugar. Depending on the initial granulometry of the products introduced into the mill, said process can last for about 5 to 60 min., preferably 10 to 50 min.

As was already mentioned above, the microcrystals which the colored icing sweeteners according to the present invention are made up of are usually characterized by an average diameter Φ below 200 μ, preferably below 150 μ, more preferably below 100 μ. In particular, Φ is on average of 5-50 μ, more preferably of 10-30 μ.

Since the mixing-refining process according to the present invention takes place by rubbing at high speed of particles with one another and onto mill walls, heat is generated during said process. Therefore, it is also provided for a system for controlling mill temperature, above all for preventing the generation of a heat excess (in particular when longer operating times are required), which might be dangerous and also damaging for products undergoing treatment. Said control system is suitably adjusted so as to keep temperature inside the mill at values near room temperature.

According to another particularly preferred feature of the invention, the process also provides for the addition of a small amount of water into the mill during the mixing-refining step (to this purpose, a mill equipped with suitable metering means for water to be added is used). The amount of water added during said step is generally not above 25% by weight with respect to the amount of sweetening mixture; more preferably, said amount of water is of about 5-20%, more preferably of about 7-15%.

Water addition during the mixing-refining step enables to obtain mixtures of final products more uniformly and deeply colored with respect to final products obtained with dry processes, without water addition, since it enables a better adhesion and/or penetration of the coloring agent into sweetener particles.

It is thus possible to obtain mixtures colored with uniformly brilliant tones, reducing at the same time the percentage of coloring agent in the mixture.

For instance, by adding water in an amount of about 10% by weight with respect to the sweetener, the percentage amount of coloring agent can be reduced from 4% to 2% by weight with respect to said sweetener.

The final product thus obtained has shown the same color tone as the analogous product obtained without water and with 4% of coloring agent, however with a higher color brilliancy and homogeneity.

Water also results in another advantage for the process according to the invention. As a matter of fact, it also acts as temperature regulator inside the mill, since it evaporates absorbing heat produced by particles rubbing with one another and with the wall. By way of summary, it can thus be stated that the process according to the invention requires water addition in an amount of 0 to 25% by weight with respect to the sweetening mixture, depending on the desired operating conditions, i.e. whether the process according to the invention is carried out with or without water.

A main object of the present invention is therefore a process for preparing colored icing sweeteners with any kind of coloring agent for use in food, characterized in that it comprises the following steps:
a) at least a sweetener and at least a coloring agent are introduced into a mill;
b) the mixture inside said mill undergoes a simultaneous mixing-refining step;
c) during said step b), an amount of water of 0-25% by weight with respect to the sweetener is added into the mill.

Said sweetening agents as in a) are preferably chosen among: sucrose, fructose, glucose, lactose, levulose, sorbitol, saccharine, aspartame, acesulfame, cyclamate or mixtures thereof. Said sweeteners are also used in diluted form with at least a non-sweetening excipient and/or additives, flavoring agents, preservatives, stabilizers. Said sweeteners are used either as granulate or as impalpable icing powder.

Another particularly preferred object of the invention is a process as previously described for preparing colored icing sucrose.

The process according to the invention enables to obtain colored icing sweeteners with any coloring agent for food use having clearly better properties than products that can be obtained by using known methods of physical mixing and of related mixing devices (rotating cubes and the like) . As a matter of fact, in this case the desired color uniformity cannot be obtained even with longer mixing times, since no close contact and deep penetration of the coloring agent into the crystalline structure of the sweetening agent takes place.

Co-milling of sweeteners and coloring agents cannot either achieve the desired results for the same reasons as described above.

The mixing methods mentioned above enable to obtain at most a partial sugar “dirtying”, which is unsatisfying. In other words, sugar white color always manages to re-emerge, even if partially.

Conversely, the close contact and deep penetration of the coloring agent into the crystalline structure of the sweetening agent are extremely important since they contribute to increase the light stability of the coloring agent, thus preventing degradation phenomena thereof, which usually result, as is known, in the formation of toxic residues and in the alteration of color brilliancy and tone.

Said results, as was widely disclosed in the present description, are achieved by the process according to the invention, which enables to obtain the desired colored icing sweetening mixtures with a single innovative step.

A further preferred object of the invention therefore includes icing sweeteners and/or sweetening mixtures colored with any kind of food coloring agent, which can be obtained through the process according to the present invention as previously described.

Said colored icing sweetening agents have proved excellent food ingredients for an easy sweetening treatment of food.

Said agents have proved particularly suitable for an application in the field of confectionery, both as internal and external ingredient, preferably so as to improve the appearance, attractiveness and organoleptic properties of any type of sweet.

In this field a particularly preferred possibility has proved the application of the icing sweetener, colored as desired, onto the surface of the finished food product by means of the sprinkling technique, in particular using as metering can an appropriate sprinkling sieve.

Therefore, another preferred feature of the present invention is the use of colored icing sweeteners obtained with the process described above for the final external treatment of food, preferably of confectionery products.

1. A process for preparing icing sweeteners colored with any kind of coloring agent for use in food, characterized in that it comprises the following steps;
a) at least a sweetener and at least a coloring agent are introduced into a mill;
b) the mixture inside said mill undergoes a simultaneous mixing-refining step;
c) during said step b), an amount of water of 0-25% by weight with respect to the sweetener is added into the mill.

2. The process according to claim 1, in which said at least a sweetener of step a) is chosen among: sucrose, fructose, glucose, lactose, levulose, sorbitol, saccharine, aspartame, acesulfame, cyclamate or a mixture thereof.

3. The process according to claim 2, in which said sweetener is diluted with at least a non-sweetening excipient and/or additives, flavoring agents, preservatives, stabilizers.

4. The process according to claims 2 and 3 claim 2, in which during step a) said sweeteners are introduced into said mill as granulate or as impalpable icing powder.

5. The process according to claim 1, in which said coloring agent of step a) is added in an amount up to maximum 4% by weight with respect to the sweetener, preferably of 2-4%.

6. The process according to claim 1, in which said simultaneous mixing-refining step of step b) is carried out at 4000-5000 rpm, at an approximately room temperature and for a time of 5-60 min., preferably of 10-50 min.

7. The process according to claim 1, in which said mixing-refining step of step b) is carried out without water addition.

8. The process according to claim 1, in which said mixing-refining step of step b) is carried out with water addition in an amount of 5-20% by weight with respect to the sweetener.

9. The process according to claim 1 for preparing a colored icing sucrose.

10. Icing sweetening mixture colored with any kind of coloring agent for use in food, which can be obtained through the process according to claim 1, having a granulometry of the component crystals on average below 200 μ of diameter.

11. A mixture according to claim 10 having a granulometry of the component crystals on average below 150 μ of diameter, preferably 100 μ.

12. A mixture according to claim 11 having a granulometry of the component crystals on average of 5-50 μ of diameter, preferably of 10-30 μ.

13. Use of a colored icing sweetener according to claim 11 as food ingredient.

14. Use of a colored icing sweetener according to claim 13 for application in the confectionery field, for improving the appearance, attractiveness and organoleptic properties of any type of sweet.

15. Use of a colored icing sweetener according to claim 13 for application onto the surface of the finished food product by means of the sprinkling technique.
